(19) United States
(12) Patent Application Publication
(10) Pub. No.: US 2026/0220604 A1
(43) Pub. Date: Jul. 30, 2026

(54) System and Method for AI-Driven Process Orchestration and Collaboration

(71) Applicant: 2539422 Ontario Inc., Whitby (CA)

(72) Inventors: Aliasgher DALAL, Whitby (CA); Tariq HABIB, Etobicoke (CA)

(21) Appl. No.: 19/452,649

(22) Filed: Jan. 19, 2026

Related U.S. Application Data
(60) Provisional application No. 63/746,319, filed on Jan. 17, 2025.

(51) Int. Cl. G06Q 10/101; G06F 8/20

(52) U.S. Cl. CPC G06Q 10/101; G06F 8/20

(57) ABSTRACT

Disclosed are systems and methods that integrate one or more large language models into live collaborative environments with multi-modal session capture, real-time transcript generation, and an adaptive mode controller. Audio, visual, and textual inputs are unified into a time-aligned, speaker-attributed transcript. A controller selects passive or active operation based on session state signals, and in active mode a trigger engine invokes the model using scheduled and intelligent triggers subject to disruption-minimizing policies. Interim outputs-including running summaries, action-item registers, and decision logs-are injected into the collaboration environment in real time and recorded back into the transcript with role-based redaction. In further embodiments, a concurrent process-orchestration framework coordinates phase-aligned agents with explicit concurrency control, dependency-graph impact analysis, and human-in-the-loop gating for cross-phase commits.

### CROSS-REFERENCE TO RELATED APPLICATIONS

This application claims the benefit of U.S. Provisional Patent Application No. 63/746,319, filed Jan. 17, 2025, the entire contents of which are incorporated herein by reference for all purposes.

### TECHNICAL FIELD

The disclosure relates to artificial intelligence and machine learning, and more specifically to systems and methods for integrating generative artificial intelligence into live, multi-party collaborative activities to augment group interactions in multi-phase processes using explicit control-plane mechanics.

### BACKGROUND

Group collaboration, such as meetings, ideation, and design sessions, often suffers from context drift, where discussions diverge from decisions and actioned items, leading to missed insights and rework. Existing collaboration tools lack real-time augmentation to address this. The emergence of LLMs capable of rapid multi-modal analysis presents an opportunity to address these issues by providing real-time contextual support in collaborations and by enabling concurrent, context-aware execution in multi-phase processes like Software Development Life Cycle (SDLC) processes or Product Development Life Cycle (PDLC). SDLC and PDLC methodologies (e.g., Waterfall, Agile, DevOps) face recurring challenges with communication bottlenecks and quality gaps.

Many processes are executed using a sequence of phases, where outputs of an earlier phase become inputs to a later phase. Software development is a common example, in which planning, analysis, design, development, testing, deployment, and maintenance are typically treated as distinct phases. Traditional phase sequencing can reduce risk by imposing structure, but it can also create inefficiencies when later-phase discoveries require rework in earlier phases.

Similarly, collaborative activities among a group or groups of humans, such as meetings or online meetings, brainstorming sessions, and cognitive exercises, can benefit from the integration of LLMs. Traditional collaboration often lacks real-time augmentation and support, which can limit creativity, productivity, and the quality of outcomes.

Language Models (LLMs) have found applications in augmenting human capabilities across various tasks. One notable application is their use in real-time activities involving interactions among multiple individuals or groups thereof, such as meetings, where LLMs can provide valuable assistance. These scenarios commonly arise in the context of product, service, or process development, but are generally applicable to other cognitive exercises. The value of LLM augmentation increases where the cognitive content of the interactions is high.

Particularly, during sophisticated thinking activities like ideation, brainstorming, conceptualization, design, and similar thinking processes conducted by teams or groups either in-person or through online platforms, effective utilization of LLMs can significantly enhance creativity and cognitive engagement.

Accordingly, there is a need for systems and methods that integrate generative AI into real-time collaboration with a focus on solving multi-modal synchronization and context drift problems. This includes a mode-switching controller to balance usefulness against disruption. There is also a need for structured application of AI to phase-based processes, using mechanisms that maintain context, coordinate concurrent contributions with explicit control-plane mechanics, and programmatically invoke LLMs based on the evolving state of the collaboration or process.

### SUMMARY

Described herein are systems and methods that employ generative artificial intelligence to augment real-time collaborative activities and to improve the execution of phase-based processes.

In one aspect, a process-orchestration system coordinates a plurality of phase agents. The system includes an orchestrator that manages concurrent operations using explicit control-plane mechanics, such as concurrency control, dependency-driven impact analysis, and human-in-the-loop gating for cross-phase changes. The orchestrator maintains a shared context and propagates updates to phase agents, allowing them to operate concurrently with enhanced consistency and conflict resolution.

In another aspect, a collaboration augmentation system integrates one or more LLMs into a live collaborative session. The system performs multi-modal session capture (e.g., audio, visual, text) and generates a unified, time-aligned transcript in real time. A mode controller adaptively selects a passive mode for manual LLM invocation or an active mode where a trigger engine programmatically invokes the LLM based on session state, subject to policies that minimize disruption and/or or maximize the LLM contribution to the cognitive discussion with the generalized or specialized expertise that it carries into its training. During the session, the system generates and injects interim outputs-such as summaries, decisions, comments, suggestions, and action items-back into the collaboration environment and applies role-based policies for redaction and access control.

In accordance with the present disclosure there is provided a system for use during collaboration sessions in a multi-phase development process, the system comprising: a processor for executing instructions; and a memory storing instructions, which when executed by the processor configure the system to provide: a plurality of phase agents, each associated with one or more phases of the multi-phase development process and adapted to generate or update a respective phase output based on received input, each phase agent further adapted to interact with one or more human participants during completion of the respective one or more phases; and an orchestrator in communication with each of the plurality of phase agents and adapted to receive phase outputs from the respective plurality of phase agents, update a shared context representing an evolving state of the multi-phase development process and providing updated inputs to respective phase agents based on at least a portion of the shared context, wherein the plurality of phase agents and orchestrator provide near-real time feedback to participants of the multi-phase development process based on the phase output of other phase agents.

In a further embodiment of the system, one or more of the plurality of phase agents comprises a large language model (LLM) interface for interacting with an LLM to provide content that may be useful to the one or more participants during completion of the respective one or more phases.

In a further embodiment of the system, the one or more phase agents interact with the LLM using one or more of: manual invocation from one or more of the participants; and automatic invocation from the one or more phase agents.

In a further embodiment of the system, the automatic invocation comprises one or more of: continuous prompting; scheduled prompting based on periodic triggers of one or more of time intervals and data volume; and intelligent prompting based on triggering criteria detected from the participants.

In a further embodiment of the system, the one or more phase agents further interact with the LLM to provide content used to generate the respective phase output.

In a further embodiment of the system, the phase output of each of the plurality of phase agents is based on one or more of: input received from the participants; input received from the orchestrator; and content from the LLM.

In a further embodiment of the system, the input received from the participants comprises multi-modal input.

In a further embodiment of the system, the respective phase output receives final approval from a participant.

In a further embodiment of the system, the multi-phase development process comprises a multi-phase software development lifecycle (SDLC) process.

In a further embodiment of the system, the orchestrator comprises a plurality of distributed orchestration components.

In accordance with the present disclosure there is further provided a method for use during collaboration sessions in a multi-phase development process, the method comprising: receiving at one of a plurality of phase agents executing on one or more computing systems, input from one or more human participants during completion of one or more phases of the multi-phase development process the one of the plurality of phase agents is associated with; generating or updating a phase output based on the input; providing the phase output from the one of the plurality of phase agents to an orchestration component executing on the one or more computing systems; receiving at the orchestration component the phase output from the one of the plurality of phase agents along with respective outputs from zero or more phase agents remaining of the plurality of phase agents; updating a shared context representing an evolving state of the multi-phase development process; providing updated inputs to respective phase agents of the plurality of phase agents based on at least a portion of the shared context, wherein the plurality of phase agents and orchestrator provide near-real time feedback to participants of the multi-phase development process based on the phase output of other phase agents.

In a further embodiment of the method, the method further comprises interacting with a Large Language Model (LLM) through an LLM interface of one or more of the phase agents to provide content that may be useful to the one or more participants during completion of the respective one or more phases.

In a further embodiment of the method, the one or more phase agents interact with the LLM using one or more of: manual invocation from one or more of the participants; and automatic invocation from the one or more phase agents.

In a further embodiment of the method, the automatic invocation comprises one or more of: continuous prompting; scheduled prompting based on periodic triggers of one or more of time intervals and data volume; and intelligent prompting based on triggering criteria detected from the participants.

In a further embodiment of the method, the one or more phase agents further interact with the LLM to provide content used to generate the respective phase output.

In a further embodiment of the method, the phase output of each of the plurality of phase agents is based on one or more of: input received from the participants; input received from the orchestrator; and content from the LLM.

In a further embodiment of the method, the input received from the participants comprises multi-modal input.

In a further embodiment of the method, the respective phase output receives final approval from a participant.

In a further embodiment of the method, the orchestrator comprises a plurality of distributed orchestration components.

In accordance with the present disclosure there is further provided a non-transitory computer readable medium storing instructions which when executed by a processor of a computer system configure the computer system to perform a method according to any of the methods above.

These and other features will be apparent from the following description, including the drawings and the appended claims.

### BRIEF DESCRIPTION OF THE DRAWINGS

Further features and advantages of the present disclosure will become apparent from the following detailed description, taken in combination with the appended drawings, in which:

FIG. 1 depicts collaboration using an autonomous concurrent agility (ACA) architecture.

FIG. 2 depicts a timeline of a multi-phase process.

FIG. 3 depicts components of a phase agent.

FIG. 4 depicts both inter-phase agent interactions and intra-phase agent interactions.

FIG. 5 depicts further components of phase agents.

FIG. 6 depicts a system for autonomous concurrent agility.

FIG. 7 depicts a method for use during collaboration sessions in a multi-phase development process.

It will be noted that throughout the appended drawings, like features are identified by like reference numerals.

### DETAILED DESCRIPTION

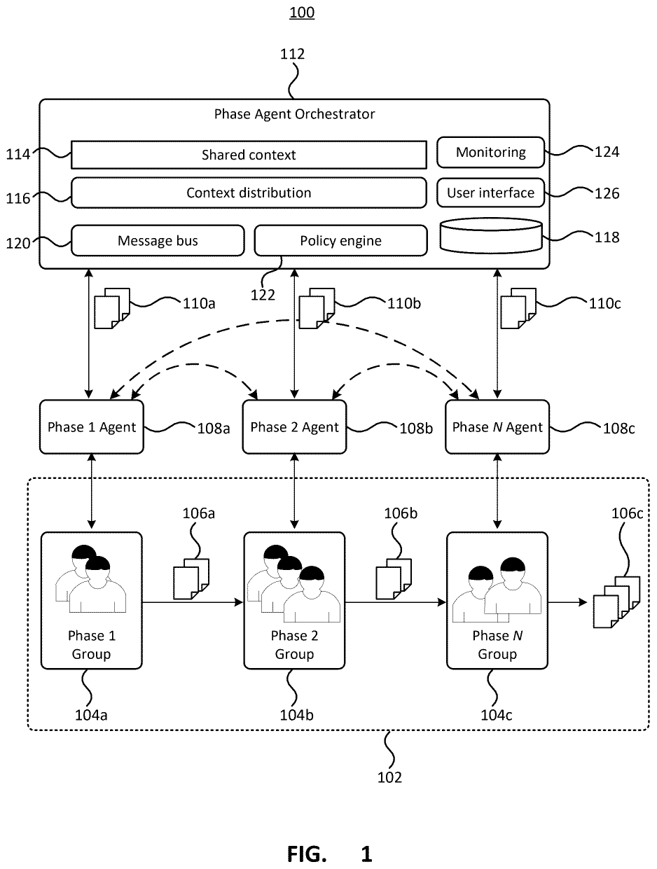

Embodiments are described below, by way of example only, with reference to FIGS. 1-7.

In the following description, specific details are set forth in order to provide a thorough understanding of embodiments of the present disclosure. However, it will be apparent to those skilled in the art that the embodiments may be practiced without these specific details. In other instances, well-known structures and techniques are not shown in detail to avoid obscuring the description.

Unless the context indicates otherwise: (i) the terms “including,” “comprising,” and the like are used in an open-ended manner; (ii) the terms “coupled” and “connected” include direct and indirect coupling or connection; and (iii) the terms “module,” “engine,” and “agent” may be implemented as software executed by one or more processors, as firmware, as hardware, or as any combination thereof.

The disclosure introduces Autonomous Concurrent Agility (ACA), a system and method by which one or more LLM-enabled autonomous agents execute responsibilities associated with distinct process phases concurrently and iteratively, coordinated by an orchestrator to maintain consistency, synchronization, and cross-phase feedback loops in real time. By leveraging LLM capabilities for rapid analysis and synthesis of multi-modal inputs, ACA removes structural barriers that impose serial ordering, thereby hyper-accelerating iterative processes while improving quality and throughput. The autonomous agents may operate completely autonomously or may incorporate human-in-the-loop to confirm functions or tasks performed by the agent.

In parallel, a collaborative augmentation system integrates LLMs as an active participant in live group interactions through two modes: a Passive Mode allowing manual prompting via text, audio, and other modalities, and an Active Mode enabling algorithmic prompting via scheduled or intelligent triggers based on contextual analysis of the ongoing collaboration. These mechanisms insert timely LLM contributions, including summaries, analyses, and formatted content, improving the creative and productive value of collaboration.

For example, in a scenario where a group of individuals participate in a collaborative process to, for instance, discuss and brainstorm ideas for a product, service, or process, the passive mode can facilitate the integration of LLMs into the collaboration. The LLMs may be interacted with through one or more of text interactions, audio interactions, video interactions, and multi-modal interactions.

With text interactions the system provides participants with a chat or text input window to prompt the LLM during the collaborative activity (e.g., a meeting). LLM responses can be included in the meeting transcription like responses from any human participant. Consequently, post-meeting or in-meeting summarization and analysis of the transcription automatically incorporates the LLM's contributions when extracting key points, concepts, requirements, or process elements. Where applicable, a Text-to-Audio interface may be provided to feed audio to the LLM as input. The agent, or agents may perform multi-modal conversion for inputs and/or outputs.

With audio interactions the system can provide participants with an Audio-to-Text interface, or Audio-to-Audio where the LLM can accept audio input as a prompt, to directly prompt the LLM as if addressing another participant. The LLM response is included in the transcription for analysis.

With multi-modal interactions the system can provide interfaces that allow participants to input graphical content (e.g., pictures, diagrams, videos) to prompt the LLM and receive output in such forms. Such content may also be included in post-session analysis. Additionally, a non-Audio/Text interface may support a method where LLM may trigger the sharing of information (e.g., presentation or whiteboard content) with participants in a live session. To maintain context, the system may provide ongoing activity summaries or convey the essence of the conversation to the LLM by summarizing contributions or providing a continuous stream of collaboration data.

In Passive Mode, participants can manually invoke the LLM using textual, audio, graphical, pictorial, or other available mechanisms. The LLM's responses are integrated into the collaborative environment, similar to a human participant, and the interaction supports various input and output forms, including text, audio, and visuals.

Building upon the Passive mode, the Active mode introduces a more natural interaction with the LLM, where, in addition to explicit prompting by a human participant, an LLM is prompted by algorithmic methods. This may be used to provide various features such as automatic summarization in which the system periodically summarizes ongoing conversations and automatically prompts the LLM, providing the summary as context to solicit a response. The summarization may be triggered periodically or based on the volume of data.

Further, LLM feedback is obtained through continuous prompting based on natural activation criteria, allowing to incorporate LLM feedback to the collaboration asynchronously. Activation criteria may involve detection of triggering conditions, for instance a participant raising a question, or unanswered questions/issues detected or incorrect fact given or assumption made or decision taken that can benefit from LLM feedback. This may include continuous feed of the collaborative activities through multi-model feed (e.g. text/image/audio/video stream).

The active mode can provide various features, including for example programmatic invocation, where LLMs are prompted using algorithmic methods without explicit human input; scheduled prompting, which uses periodic triggers based on time or data volume to provide context for LLM responses; and intelligent triggering, which involves ad hoc prompts based on key points, patterns, or continuous input streams to elicit useful responses.

This disclosure provides a framework that utilizes Generative AI capabilities for the concurrent execution of tasks across multi-phase and multi-stakeholders SDLC process. SDLC typically include Planning, Analysis, Design, Development, Testing, Deployment, and Maintenance phases.

In one embodiment of the ACA framework, the framework comprises autonomous AI agents. An AI agent may be a software program that can interact with its environment, collect data, and use that data to perform self-determined tasks to meet predetermined goals, including prompting or triggering one or more LLMs. These agents operate independently within each SDLC phase while concurrently and collaboratively engaging stakeholders from other phases in a real-time feedback loop. Each agent is capable of understanding the needs and context of its phase, and interacting with agents from other phases to gather information, analyze dependencies, and provide feedback. A central orchestrator manages these interactions, ensuring consistency and enhancing overall productivity. The agents utilize LLMs to rapidly analyze large amounts of multi-modal content, synthesize it into cohesive and formatted outputs in near real-time, and propagate changes and feedback across the phases seamlessly.

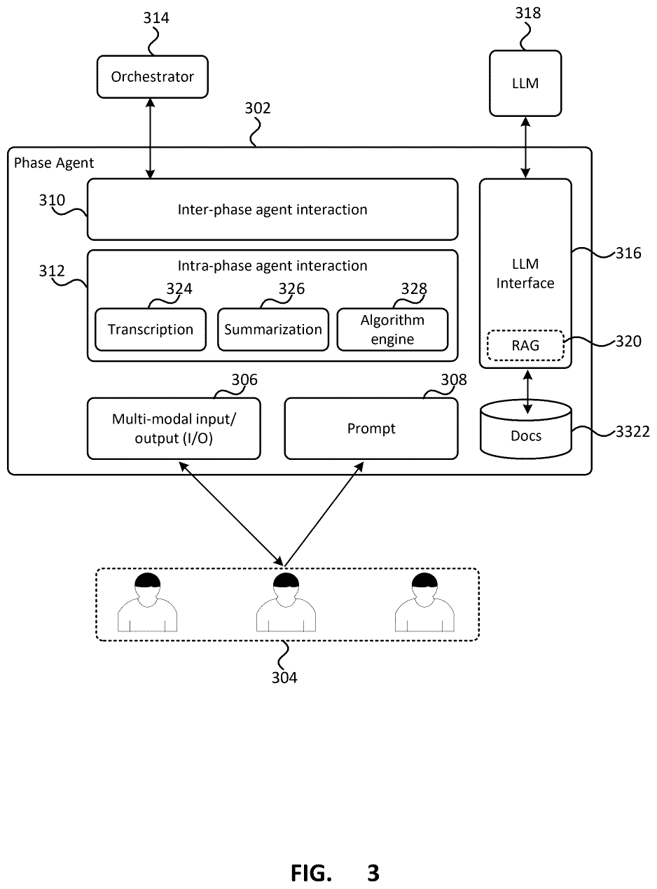

AI-driven agents operate independently within each phase, gathering input and feedback from other phases, analyzing and summarizing impacts, and incorporating changes in near real-time. This reduces the need for human involvement in manually intensive tasks such as comprehension, research, analysis, and documentation. In addition, ACA framework readily propagates the changes in one phase to others allowing for rapid feedback from stakeholders. FIG. 3 illustrates a conceptual diagram of ACA, depicting the flow of information across SDLC phases. Each phase is represented by an AI agent responsible for processing user input and collaborating with agents in other phases. A central orchestrator oversees the overall process to maintain coherence.

With reference to the drawings, like reference numerals refer to like elements throughout. The following descriptions of FIGS. 1 through 7 explain representative embodiments and system/data flows using the components identified by their reference numerals.

FIG. 1 depicts a collaboration system using an autonomous concurrent agility (ACA) architecture. The system 100 allows a multi-phase collaboration process 102 involving a plurality of individuals 104a, 104b, 104c (referred to collectively as participants 104) participating in one or more collaborative sessions associated with a particular phase of the multi-phase process. While the multi-phase process may be a wide range of processes, one example is a software development lifecycle process in which software is developed through a plurality of different stages such as planning, designing, developing, testing and deploying. It will be appreciated that the actual phases may differ. At each phase in the multi phase process participants 104 may collaborate to complete the tasks of the phase and generate a final phase output 106a, 106b, 106c (referred to collectively as phase outputs 106). The phase outputs 106 may vary depending on the phases but may broadly be some artifact such as a specification document, design document, program code, or other text, audio, video, etc.

Previously, each phase of the multi-phase process was completed sequentially. Although the phases were generally completed sequentially, there may be overlap between the phases. For example, if the multi-phase process comprises developing a piece of software and the phases include designing, developing and deploying the software, while the designing phases may be substantially completed prior to starting development, it is possible for the development phase to begin while final details of the design is being completed. Similarly, the deployment phase may begin before fully completing the development phase. Further, while the multi-phase process is described as being a software development process in which the process is completed once the software is deployed, it will be appreciated that the software development process may be applied to portions of an overall software application. For example, the multi-phase process may be applied to designing, developing and deploying a new feature or functionality for existing software applications.

The sequential nature of the multi-phase process can slow the process as each phase is substantially completed, or at least partially completed, prior to beginning the next phase of the process. As described further below, the sequential process can be improved by using a plurality of phase agents 108a, 108b, 108c (referred to collectively as phase agents 108). The phase agents can mimic or model the work performed by the participants 104 at each collaborative phase. For example, continuing with the software development process described above, a first phase agent 108a may be associated with the design phase, a second phase agent 108b may be associated with the development phase, and a third phase agent may be associated with a deployment phase. It is noted that while the phase agents 108 are described as being associated with a single phase of the multi-phase process, it is possible for a phase agent to be associated with one or more phases.

Each phase agent receives input and processes the input to provide a phase output 110a, 110b, 110c. Although not depicted in FIG. 1, one or more of the phase agents may generate the phase outputs using one or more large language models (LLM) to analyze input data and generate content for the phase output. The content generated by the LLMs may be used directly as the phase outputs or may be further processed by the phase agents to generate the phase outputs. Further, multiple queries or prompts to the LLM may be used to generate the phase outputs. The phase outputs 110 generated by phase agents may be the same or similar to the phase outputs 106 depicted as being generated by the groups of participants 104. When the phases are finalized, for example after a final approval by one or more of the participants, or by the phase outputs being determined to be in a final state, the phase outputs 110 from the phase agents may be the same as the phase outputs 106 depicted as being generated by the participants 104.

As depicted, the phase agents 108 may receive input from the phase group participants. The phase outputs 110 are depicted as being provided to a phase orchestrator 112. The phase outputs may also be provided to, or displayed to, the group participants. The phase orchestrator coordinates the multiple phase agents and can distribute information between phase agents, which may be used as inputs by the phase agents to generate the phase outputs. The orchestrator can maintain a shared context 114 that represents a current state of the multi-phase process. The orchestrator can generate, or update, the shared context based on the phase outputs from the phase agents. Rather than providing the phase outputs to the orchestrator, the phase agents may provide data that can be used by the orchestrator to maintain the shared context. As an example, rather than providing the phase output, the phase agent may provide an encoding of the phase output which can be provided to the orchestrator. The orchestrator can generate and maintain the shared context based on the data received from the plurality of phase agents 108. The orchestrator may include context distribution functionality 116 that can provide the shared context, or portions of the shared context to the phase agents. The portion of the shared context provided to the phase agents may be a portion of the shared context, or data based on a portion of the shared context, that may be relevant to the phase agent for generating the phase output.

The orchestrator may use, for example a shared datastore 118 to persist artefacts generated by the phase agents and state information. An event bus 120 or other messaging mechanism may be used by the context distribution functionality to propagate messages among agents. The orchestrator may include a policy/guardrail engine 122 or mechanism that enforces safety and compliance constraints across operations. Monitoring/telemetry 124 functionality may collect operational metrics. The orchestrator, or other components of the system including one or more of the phase agents may include operator/user interfaces 126 that permit configuration and oversight of the system.

The orchestrator allows the phase agents to feed data about the phase to other phases. This may allow different phase agents to adjust their output based on the phase output of other phase agents. For example, during the design phase, when the group of participants in the collaborative phase session, or sessions, determine a design of the software, the design may be used to generate the shared context which can be distributed to other phase agents, which may develop a program based on the design and deploy the program. There may be problems or issues identified by the development or deployment agents which could be helpful in adjusting the design. Accordingly, the phases may be initially completed, or partially completed, by the phase agents simultaneously, or substantially simultaneously. The phase agents may then present the information to the individuals participating in the phase sessions to complete the phase. The information provided by the other phase agents may be used by the phase participants to more quickly complete the phases.

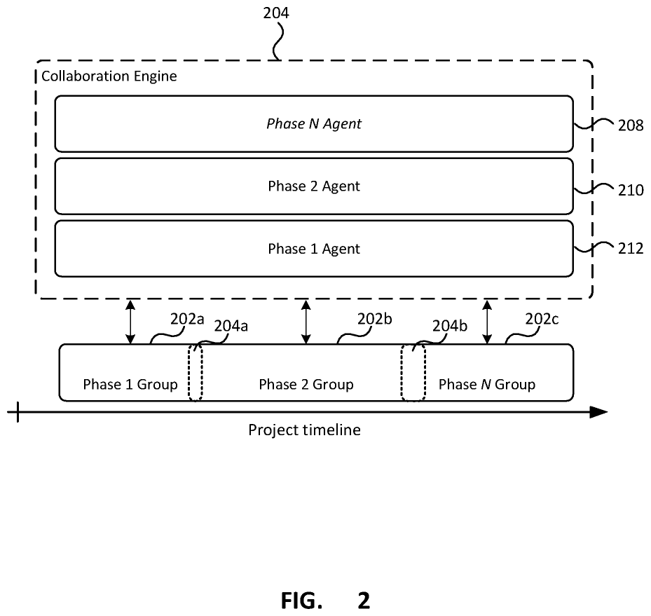

FIG. 2 depicts a timeline of a multi-phase process. As depicted, a multi-phase process may be carried out by a plurality of participant group sessions 202a, 202b, 202c. As depicted, each phase group may complete the phase during the multi-phase process. The performance of subsequent phases may have some amount of overlap 204a, 204b, between the phases. A collaboration engine or system 206 may be used to increase the overlap between the phases and allow a typical sequential multi-phase process to be performed concurrently, or at least in less time. As depicted, the collaboration engine 206 may include a plurality of phase agents 208, 210, 212 which are each associated with one or more respective phases of the multi-phase agents. While the phase groups of participants may complete the phases in a sequential manner, the phase agents all operate concurrently and can provide useful information to the current phase group participants based on the results of the phase agents associated with other phases. In this manner, the completion of each phase by the respective phase groups may be accelerated. Further, the overlap between performing different tasks by respective phase groups may be increased since the phase agents may provide needed information or context to complete, or at least start, a phase at an earlier time in the process.

FIG. 3 depicts components of a phase agent. The phase agent 302 may interact with one or more participants 304 of a collaborative session for a particular phase or phases in the multi-phase process. The phase agent may include various interfaces for interacting with the participants. For example, the phase agent may include a multi-modal input/output interface 306 that allows the phase agent to capture multi-modal input from the collaborative session. Additionally or alternatively, the phase agent may include a prompt interface 308 allowing the phase participants to provide prompts or queries to the phase agent. The prompt interface may receive prompts, or queries, from participants and assemble or build a prompt for sending to the LLM. The resulting response can be presented to the users as well as inserting into a time-aligned transcript of the collaborative phase session so that the contributions of the LLM are preserved alongside the human participants'contributions.

Similarly, the multi-modal input can capture audio and/or video streams and which can be fed to an automatic speech recognition stage along with possibly a video analysis stage. Additional visual content such as images and/or documents can be fed to an optical character recognition (OCR) stage and/or vision analysis stage. The multi-modal input may be fed directly to one or more LLMs or other trained machine learning models to generate the agent outputs which can be presented to the collaboration participants as well as being fed to the collaboration summary and/or time-aligned transcript.

The phase agent may generate from the collaboration session of the individual participants summaries, action items, decision logs, etc. The phase agent may also generate artefacts to create structure outputs contemporaneously. The generated artefacts may take a wide range of formats such as documents, images, audio/video content, code, websites, etc.

It will be appreciated that the particular interfaces used for interactions between the phase agents and phase participants may vary. Further, while depicted as being a direct interaction between the phase agent and participants, it is possible for the interactions to be mediated by one or more intervening devices. For example, if one or more of the participants are joining the collaboration online, the interaction with the phase agent may be through an intermediary interface or component on the participants computer or computing device.

The multi-modal input may allow various types of input to be captured, either automatically or manually from the participants in the phase group during the collaboration session. The multi-modal inputs may include for example, audio, video, images, text-based, white-board sessions, etc. The inputs may be continuously captured, periodically captured, automatically captured based on triggering events, or may be manually captured. While depicted as a single multi-modal interface, it is possible to use one or more single-mode interfaces.

The content captured by the interfaces, whether the multi-modal interface, prompt interface, other user interaction interfaces, may be used by inter-phase agent interaction functionality 310 and intra-phase agent interaction functionality 312. The inter-phase agent interaction functionality 310 uses the input from the phase participants, as well as input from an orchestrator 314 based on the shared context, to generate a phase output which can be shared with the orchestrator to build the shared context and distributed to other phase agents. The phase output generated by the inter-phase agent interaction functionality may also be presented to the participants of the phase session.

In addition to providing the inter-phase agent interaction functionality which allows the concurrent operation of the different phase agents, the phase agents may also provide various intra-phase agent interaction functionality 312 which can provide useful information to participants of the phase session. Both the inter and intra-phase agent interaction functionality may use a LLM interface 316 to access one or more LLMs 318 to generate the phase output, or other output or content useful to the collaboration participants 304. The LLM interface may incorporate a retrieval augmented generation (RAG) pipeline for augmenting LLM prompts with content retrieved from one or more datastores 324 to improve the performance of the prompt.

The intra-phase agent interaction functionality may provide various functionality for the phase's collaboration session, or sessions. For example, it may include transcription functionality 324 that can provide a transcript of the collaboration session, which may include the interactions with the LLM and associated results. In addition to providing a transcript of the collaboration, the functionality may also provide summarization functionality 326 of the collaboration session. The summarization may be based on the transcript, audio records, video recordings, interactions between the participants and other participants, interactions between the participants and the phase agent, and/or interactions between the participants and other systems such as internet searches, accessing of documents etc.

The intra-phase agent interaction functionality may further include for example an algorithm engine that can algorithmically query the LLM to generate relevant data for the participants. For example, the algorithm engine may determine that the participants are considering two different options and may generate one or more relevant prompts to compare the two options or provide other information such as costs, implementation times, pros/cons of the different options that may be useful to the participants in deciding which option to pursue.

The collaboration system allows real-time, or near real-time interim generation of summarization, analysis, and output generation, enabling real-time collaborators to assess the essence of their collaboration, make necessary changes, or make decisions

Both the inter-phase agent interaction functionality and the intra-phase agent interaction functionality may use input from the interfaces including from the multi-modal interfaces and prompt interfaces as depicted. Although only the inter-phase agent interaction functionality is depicted as interfacing with the orchestration component, it is possible for the intra-phase agent interaction functionality to also interface with the orchestrator for example in order to present relevant context from other phase agents to the phase participants. The phase agent may interact with the participants in a passive or active mode. While the following describes the active or passive mode being applied for all participants, it is possible for different participants to have different modes. Further, while described as having the same mode applied to all modes of interaction, it is possible for different captures modes to be used for different input modes. For example, one participant may provide for active mode collection for audio and video content while another participant has active mode collection for audio only and has manual collection for video content. It will be appreciated that the above is only an example and any combination of the collection modes for different participants and input modes are possible.

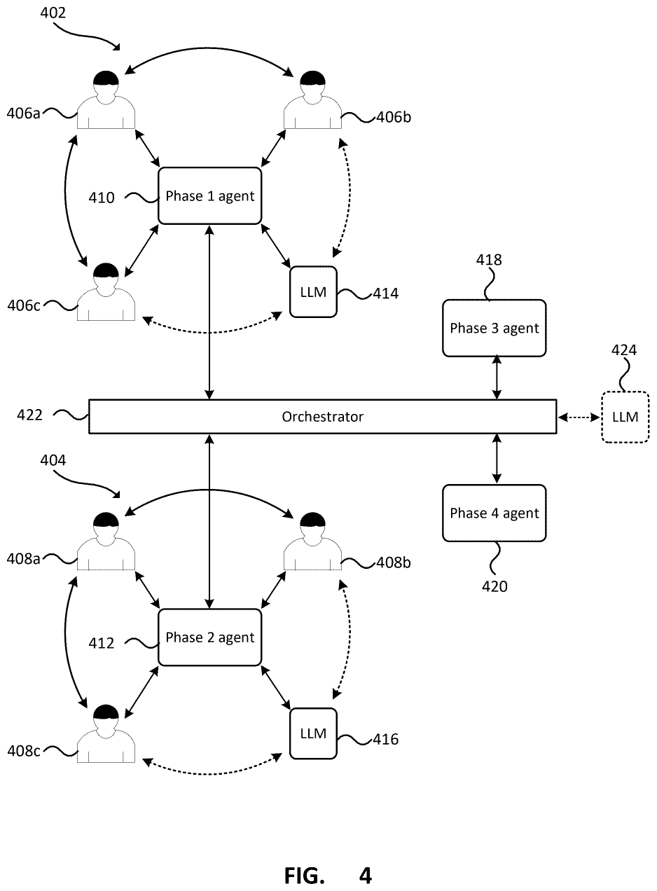

FIG. 4 depicts both inter-phase agent interactions and intra-phase agent interactions. As depicted, a plurality of collaborative phase sessions 402, 404 may be held in which one or more human participants collaborate to complete the task or tasks for a particular phase of a multi-phase process. For example, the phase 1 collaborative session includes a plurality of human participants 406a, 406b, 406c and the phase 2 collaborative session includes a plurality of human participants 408a, 408b, 408c. Each collaborative session includes a phase agent 410, 412 that provides functionality for incorporating an LLM 414, 416 into the collaborative session. The phase agent may allow the LLM to participate in the collaboration session in a similar manner as the human participants.

As depicted in FIG. 4, the multi-phase process is a 4-phase process. While it is possible for each phase to simultaneously have collaborative sessions occurring, in FIG. 4 only phases 1 and 2 are depicted as having an active collaborative session. However, regardless of whether there are currently human participants for each stage, each stage has an active phase agent 410, 412, 418, 420. The phase agents, whether currently in an active collaboration with human participants or not, can provide context to an orchestrator 422 that maintains a shared context of the multi-phase process and distributes relevant portions of the shared context to the relevant phase agents. The phase agents may generate phase outputs using the information from the orchestrator as well as information based on the collaboration session of the participants if occurring. The orchestrator may use an LLM 424 for generating the shared context and/or distributing portions of the shared context to the respective phase agents.

As described, the phase agents and orchestrator can use information collected from human participants during one or more collaboration sessions for other phases to generate phase outputs that can in turn be used to update a shared context and update other phase agents. The updated context distributed to the different phase agents can be used directly to update the phase output of a phase agent and/or presented to the participants of the collaborative phase session or sessions. In addition to providing a feedback loop between all of the phases, regardless of if a collaborative session is occurring or not, the phase agents may also provide useful information to the participants during a collaborative session or sessions.

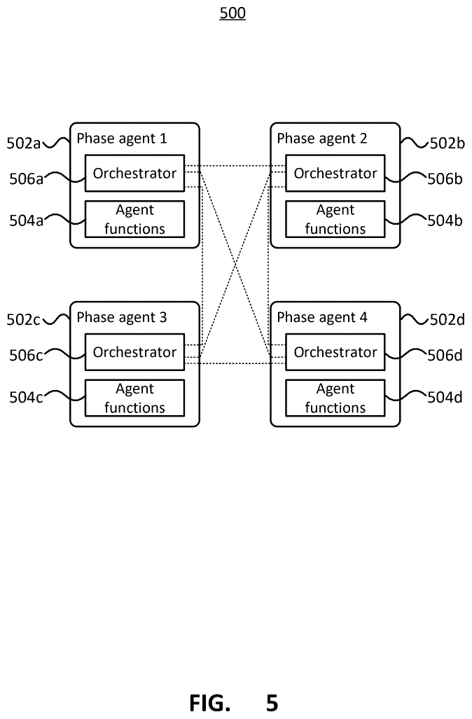

FIG. 5 depicts further components of phase agents. The above has described the orchestrator as being implemented as a single element separate from the phase agents. The system 500 is depicted as comprising a plurality of phase agents 502a, 502b, 502c, 502d. Each of the plurality of phase agents include agent functionality 504a, 504b, 504c, 504d which may be associated with performing one or more of the phases of the multi-phase process. Additionally, or alternatively, one or more of the agents may provide only a portion or task of one or more phases of the multi-phase process. As depicted, the orchestration functionality is provided as distributed orchestrator functionality 506a, 506b, 506c, 506d for coordinating operation of the plurality of agents. Although depicted as being implemented in each of the plurality of phase agents, the distributed orchestrator may be implemented in a subset of the phase agents. Further, although depicted as being part of the phase agents, the distributed orchestrator components may be implemented outside of the phase agent functionality.

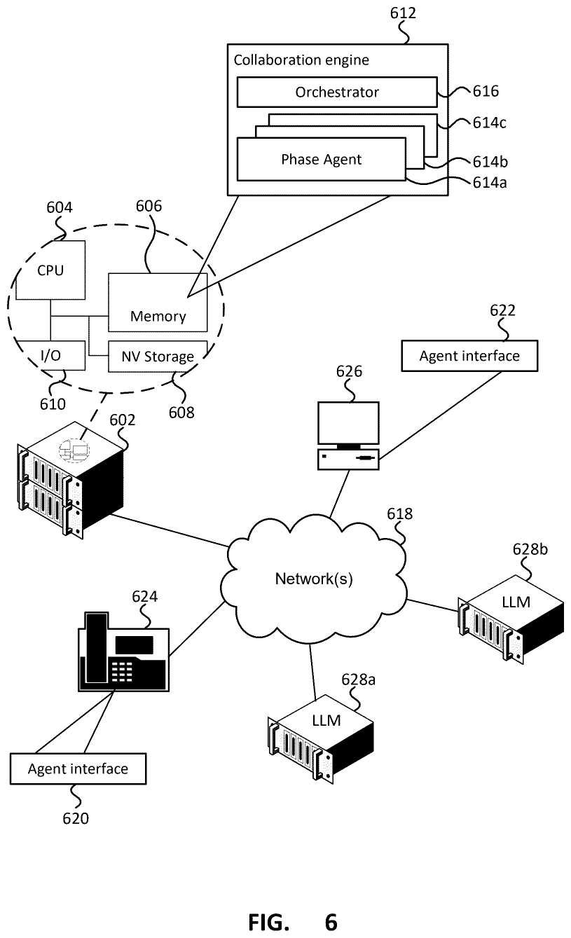

FIG. 6 depicts a system for autonomous concurrent agility. The system includes one or more computing devices 602 that may implement one or more portions of the collaborative engine. The one or more computing devices may each comprise a processor (CPU) 604 for executing instructions, a memory unit 606 for storing instructions and non-volatile storage 608 for data and instructions. One or more input/output (I/O) interfaces 610 may be provide for functionality connecting the computing device to one or more additional input and/or output devices. The instructions stored in the one or more memory units, when executed by the one or more CPUs, may configure the one or more computing devices to provide various functionality including the collaboration engine 610. The collaboration engine may provide various functionality described herein, including for example a plurality of phase agents 614a, 614b, 614c and an associated orchestrator 616.

The computing device(s) implementing the collaboration engine may be in communication with one or more computing device using one or more communication networks 618 which may include both wired and wireless communication protocols. The additional computing devices may include devices that include agent interfaces 620, 622 that allow the devices to interface with one or more phase agents. For example a telephone 624 may include an agent interface that allows a human participant to connect to a phase agent during a collaboration session. Similarly, a computing device 626 may include a phase agent interface allowing an individual or individuals to participate in a collaborative session and interact with the participants and phase agent. The computing devices may provide various functionality such as one or more LLMs 628a, 628b.

The implementation depicted in FIG. 6 is only one example implementation and the functionality described herein may be implemented in various manners.

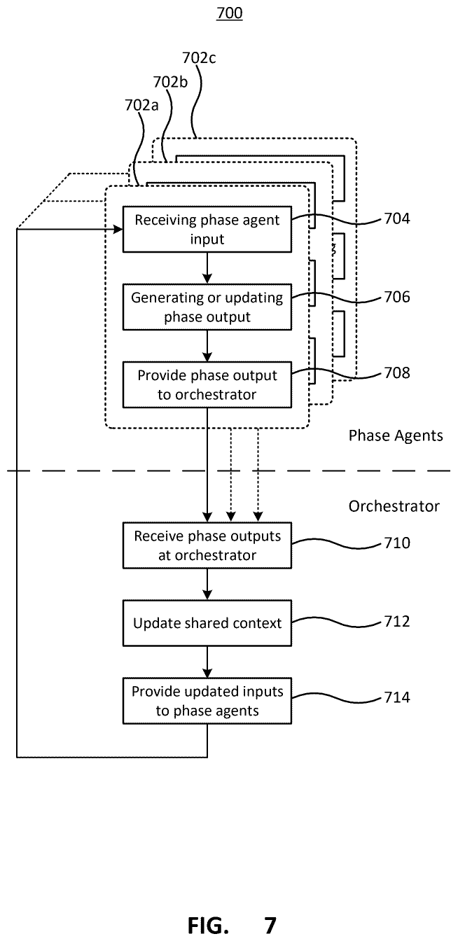

FIG. 7 illustrates depicts a method for use during collaboration sessions in a multi-phase development process. The method 700 includes steps performed by phase agents and steps performed by an orchestrator. While the steps are depicted as being performed sequentially between the phase agents and orchestrator, the steps may be performed concurrently.

As depicted, the method may be performed by a plurality of phase agents 702a, 702b, 702c. Each phase agent may perform the same or similar steps concurrently. A phase agent input is received (704). The phase agent input may comprise information from the orchestrator that is generated at least in part based on a shared context of the state of the multi-phase process. Additionally, the phase agent input may be based on, at least in part, participant interactions. The participant interactions may be processed for example by OCR functionality, LLMs, other ML models, etc. For example, the participant interactions may include multi-modal input such as captured audio/video, text, documents, images, code, etc. captured from one or more of the participants. Based on the phase input, a phase output is generated, or updated (706) and provided to the orchestrator (708). It is possible to provide the phase output or a representation of the phase output to the orchestrator. Further, the entire phase output, or representation thereof may be provided to the orchestrator, or only a portion of the phase output, or representation thereof may be provided. For example, if participant interactions during the collaboration session result in the phase agent updating the phase output, only the changes of the phase output, or representations of the changes may be provided to the orchestrator.

The orchestrator receives the phase outputs from various phase agents as they are generated or updated (710) and updates a shared context (712) representing a current state of the multi-phase process. The different phase agents can provide updated phase outputs asynchronously and the orchestrator can update the shared context as the different phase outputs are receive. When the shared context changes, updated inputs can be provided from the orchestrator to each of the phase agents (714). The orchestrator may determine which portions of the shared context to provide to the respective phase agents. Rather than provide a portion of the shared context to respective phase agents, the orchestrator may use the respective portions of the shared context to generate the updated input that is provided to the phase agents. As depicted, once the phase agents receive the updated input they may again generate or update their phase outputs, possibly with further input from participants of an ongoing collaborative session.

In one example implementation of the collaboration system, the system is adapted for use in a software development lifecycle (SDLC) process, the system may include a set of autonomous AI agents for the different phases of the SDLC process. A Planning Phase Agent may utilize AI-driven data analysis to create planning documents, establish scope, and gather inputs from stakeholders and other agents, enabling real-time adjustments. The change is then fed back to the rest of the SDLC phases, cascading the change in a rapid and smooth manner. An Analysis Phase Agent may process stakeholder requirements, formulate features and specifications, and collaborate with other phases. A Design Phase Agent may generate architectural blueprints, wireframes, mockups, and use cases. The agent may receive input from stakeholders and other phases, while collaborating with other phases by sharing its own analysis, data, and outputs. A Development Phase Agent may generate code, manage prototype creation, unit test scripts, and code analysis, and continuously refine the codebase based on concurrent testing feedback. The agent may receive input from stakeholders and other phases, while collaborating with other phases by sharing its own analysis, data, and outputs, and may externally collaborate with DevOps and other tools in performing its task. A Testing Phase Agent may be responsible for test planning, case generation, execution, and collaboration with other phases. It may externally collaborate with different DevOps tools to perform its tasks and may receive input from stakeholders and other phases, while collaborating with other phases by sharing its own analysis, data, and outputs. A Deployment Phase Agent may develop deployment plans and scripts, manage automated deployment, and scalability operations. It may externally collaborate with myriads of devops tools to perform its tasks and may receive input from the stakeholders and other phases, while collaborating with other phases by sharing its own analysis, data, and outputs. A Maintenance Phase Agent may monitor system performance, coordinate enhancements, and ensure security and integrity of the operational system. It can externally collaborate with myriads of observability tools to perform its tasks and may receive input from stakeholders and other phases, while collaborating with other phases by sharing its own analysis, data, and outputs. The interactions between autonomous agents may be managed by a central orchestrator, which ensures consistency, coherence, and synchronization across all phases, and enhances overall productivity by coordinating concurrent activities.

In operation, the system allows for concurrent execution where agents operate independently within their respective phases while continuously communicating with agents in other phases. A real-time feedback loop propagates changes and updates in one phase across other phases in real-time, enabling immediate adjustments. This can reduce manual effort by minimizing the need for human involvement in time-consuming tasks such as research, analysis, and documentation.

Advantages of the system include for example dynamic workflows, as the system enables dynamic and fluid workflows by removing serialization constraints. The system also offers accelerated processes, reducing development time and accelerating iterative processes. Further, it provides enhanced quality by improving the quality of outputs through continuous feedback and AI-driven analysis, and improved efficiency by enhancing overall efficiency by optimizing resource utilization and reducing bottlenecks.

The ACA framework outlined above for the SDLC processes can be applied to a wide variety of enterprise, organizational, and industrial processes where generative AI capabilities can be employed to optimize and hyper-accelerate the process.

The combination of the ACA framework and the collaborative system provides for stakeholder interactions within and across SDLC phases to be treated as collaborative activities enhanced by LLMs. This integrated approach optimizes processes and outcomes by leveraging AI capabilities in both structured process orchestration and dynamic human collaboration.

While a particular implementation is described with respect to a SDLC process, the multi-phase process may be other processes in which a plurality of different steps or phases are performed. The phase agents described herein allow the multi-phase process, which is typically performed in a serial manner, to be performed concurrently, or at least overlapping portions of the multi-phase processes. The phase agents can perform one or more steps or phases in the multi-phase process. The multi-phase process may be defined according to the different phases and the different inputs and outputs of each phase. The agents can be configured to perform one or more tasks of the specified phases and may include additional input such as content captured during live collaboration sessions involving human participants and one or more of the agents. The output of the agents, or one or more of the tasks performed by the agents may be approved, authorized, or otherwise controlled by a human-in-the-loop in order to provide control over the feedback loop between agents, although it is possible to be completely automated by the agents.

Each element in the embodiments of the present disclosure may be implemented as hardware, software/program, or any combination thereof. Software codes, either in its entirety or a part thereof, may be stored in a computer readable medium or memory (e.g., as a ROM, for example a non-volatile memory such as flash memory, CD ROM, DVD ROM, Blu-ray™, a semiconductor ROM, USB, or a magnetic recording medium, for example a hard disk). The program may be in the form of source code, object code, a code intermediate source and object code such as partially compiled form, or in any other form.

It would be appreciated by one of ordinary skill in the art that the system and components shown in FIGS. 1-7 may include components not shown in the drawings. For simplicity and clarity of the illustration, elements in the figures are not necessarily to scale, are only schematic and are non-limiting of the element structures. It will be apparent to persons skilled in the art that a number of variations and modifications can be made without departing from the scope of the disclosure.

What is claimed is:

1. A system for use during collaboration sessions in a multi-phase development process, the system comprising:
a processor for executing instructions; and
a memory storing instructions, which when executed by the processor configure the system to provide:
a plurality of phase agents, each associated with one or more phases of the multi-phase development process and adapted to generate or update a respective phase output based on received input, each phase agent further adapted to interact with one or more human participants during completion of the respective one or more phases; and
an orchestrator in communication with each of the plurality of phase agents and adapted to receive phase outputs from the respective plurality of phase agents, update a shared context representing an evolving state of the multi-phase development process and providing updated inputs to respective phase agents based on at least a portion of the shared context,
wherein the plurality of phase agents and orchestrator provide near-real time feedback to participants of the multi-phase development process based on the phase output of other phase agents.

2. The system of claim 1, wherein one or more of the plurality of phase agents comprises a large language model (LLM) interface for interacting with an LLM to provide content that may be useful to the one or more participants during completion of the respective one or more phases.

3. The system of claim 2, wherein the one or more phase agents interact with the LLM using one or more of:
manual invocation from one or more of the participants; and
automatic invocation from the one or more phase agents.

4. The system of claim 3, wherein the automatic invocation comprises one or more of:
continuous prompting;
scheduled prompting based on periodic triggers of one or more of time intervals and data volume; and
intelligent prompting based on triggering criteria detected from the participants.

5. The system of claim 2, wherein the one or more phase agents further interact with the LLM to provide content used to generate the respective phase output.

6. The system of claim 5, wherein the phase output of each of the plurality of phase agents is based on one or more of:
input received from the participants;
input received from the orchestrator; and
content from the LLM.

7. The system of claim 6, wherein the input received from the participants comprises multi-modal input.

8. The system of claim 5, wherein the respective phase output receives final approval from a participant.

9. The system of claim 1, wherein the multi-phase development process comprises a multi-phase software development lifecycle (SDLC) process.

10. The system of claim 9, wherein the orchestrator comprises a plurality of distributed orchestration components.

11. A method for use during collaboration sessions in a multi-phase development process, the method comprising:
receiving at one of a plurality of phase agents executing on one or more computing systems, input from one or more human participants during completion of one or more phases of the multi-phase development process the one of the plurality of phase agents is associated with;
generating or updating a phase output based on the input;
providing the phase output from the one of the plurality of phase agents to an orchestration component executing on the one or more computing systems;
receiving at the orchestration component the phase output from the one of the plurality of phase agents along with respective outputs from zero or more phase agents remaining of the plurality of phase agents;
updating a shared context representing an evolving state of the multi-phase development process;
providing updated inputs to respective phase agents of the plurality of phase agents based on at least a portion of the shared context,
wherein the plurality of phase agents and orchestrator provide near-real time feedback to participants of the multi-phase development process based on the phase output of other phase agents.

12. The method of claim 11, further comprising interacting with a Large Language Model (LLM) through an LLM interface of one or more of the phase agents to provide content that may be useful to the one or more participants during completion of the respective one or more phases.

13. The method of claim 12, wherein the one or more phase agents interact with the LLM using one or more of:
manual invocation from one or more of the participants; and
automatic invocation from the one or more phase agents.

14. The method of claim 13, wherein the automatic invocation comprises one or more of:
continuous prompting;
scheduled prompting based on periodic triggers of one or more of time intervals and data volume; and
intelligent prompting based on triggering criteria detected from the participants.

15. The method of claim 12, wherein the one or more phase agents further interact with the LLM to provide content used to generate the respective phase output.

16. The method of claim 15, wherein the phase output of each of the plurality of phase agents is based on one or more of:
input received from the participants;
input received from the orchestrator; and
content from the LLM.

17. The method of claim 16, wherein the input received from the participants comprises multi-modal input.

18. The method of claim 15, wherein the respective phase output receives final approval from a participant.

19. The method of claim 11, wherein the orchestrator comprises a plurality of distributed orchestration components.

20. A non-transitory computer readable medium storing instructions which when executed by a processor of a computer system configure the computer system to perform a method comprising:
receiving at one of a plurality of phase agents executing on one or more computing systems, input from one or more human participants during completion of one or more phases of the multi-phase development process the one of the plurality of phase agents is associated with;
generating or updating a phase output based on the input;
providing the phase output from the one of the plurality of phase agents to an orchestration component executing on the one or more computing systems;
receiving at the orchestration component the phase output from the one of the plurality of phase agents along with respective outputs from zero or more phase agents remaining of the plurality of phase agents;
updating a shared context representing an evolving state of the multi-phase development process;
providing updated inputs to respective phase agents of the plurality of phase agents based on at least a portion of the shared context,
wherein the plurality of phase agents and orchestrator provide near-real time feedback to participants of the multi-phase development process based on the phase output of other phase agents.
1.
